(19) United States
(12) Patent Application Publication
(10) Pub. No.: US 2012/0261273 A1
(43) Pub. Date: Oct. 18, 2012

(54) ELECTRODE FOR ELECTROCHEMICAL DEVICE AND METHOD FOR DETECTING HYDROGEN PEROXIDE

(75) Inventors: Mu-Yi Hua, Tao-Yuan (TW); Hsiao-Chien Chen, Taichung City (TW); Yaw-Terng Chern, Taipei City (TW); Rung-Ywan Tsai, Hsinchu County (TW); Shi-Liang Chen, Taoyuan County (TW); Yan-Shium Chen, New Taipei City (TW)

(73) Assignee: Chang Gung University, Kwei-Shan (TW)

(21) Appl. No.: 13/482,264

(22) Filed: May 29, 2012

Related U.S. Application Data
(63) Continuation-in-part of application No. 13/105,304, filed on May 11, 2011.

(30) Foreign Application Priority Data
Aug. 4, 2010 (TW) 099125888
Aug. 4, 2010 (TW) 099125889
Aug. 20, 2010 (TW) 099127939

(51) Int. Cl. G01N 27/30; G01N 27/26

(52) U.S. Cl. 205/777.5; 204/290.11; 205/782

(57) ABSTRACT

An electrode for an electrochemical device includes a conductor and an active layer. The active layer is formed on the conductor and includes a polymer with a functional group represented by the following formula (A) or (B), and a carboxylated material containing a carboxylic acid group.

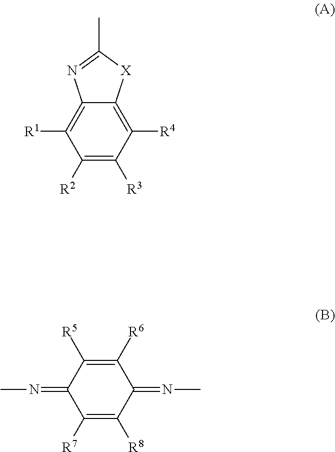

### CROSS-REFERENCE TO RELATED APPLICATION

This application is a continuation-in-part (CIP) of U.S. patent application Ser. No. 13/105,304, filed on May 11, 2011, the entire disclosure of which is incorporated herein by reference.

### BACKGROUND OF THE INVENTION

1. Field of the Invention

This invention relates to an electrode for an electrochemical device and a method for detecting hydrogen peroxide using the electrode.

2. Description of the Related Art

Hydrogen peroxide (H₂O₂) is a reactive oxygen species and a byproduct of several types of oxidative metabolism. Because accurate determination of H₂O₂ is of practical importance in the clinical, environmental and industrial fields, increasing interest has focused on fabrication of reliable H₂O₂ biosensors. Due to their high selectivity and sensitivity, electrochemical devices have been used extensively to detect H₂O₂.

In electrochemical devices, electrodes used to detect analytes are either enzyme-based or enzyme-free electrodes. Enzyme-free electrodes can be made by forming an active layer on a conductor. The materials for the active layer can be inorganic materials (i.e., metallic nano-particles, metallic oxides, transition metals, carbon nanotubes, etc.), organic materials (i.e., polyamic acid, polyaniline, poly(aniline-co-p-aminophenol)) or organic-inorganic materials (i.e., polyaniline-carbon nanotubes).

As to an electrochemical device using the enzyme-free electrode, an oxidation potential (approximately 0.5 V to 0.7 V) is usually measured in this device to determine the amount of hydrogen peroxide. Since the oxidation potential is susceptible to interference with other undesired substances, such as uric acid (UA) and ascorbic acid (AA), in a test sample, the specificity for hydrogen peroxide is reduced and the accuracy of the test result would be adversely affected. Therefore, improvements for the electrodes of the electrochemical devices are aimed at detecting H₂O₂ at reduction potential to eliminate the interference of interfering molecules.

W. Zhao et al. disclosed a multi-wall carbon nanotube/silver nanoparticle nanohybrids modified gold electrode for H₂O₂ sensors (Talanta 2009, 80, 1029-1033). This electrode can be operated under −0.15 V to −0.6 V, and has a sensitivity of 1.42 μA/mM, linear detection range of 0.05 mM to 17 mM, and a response time as low as 5 seconds.

The inventors of the present invention have published using poly (N-butyl benzimidazole)-modified gold electrode for the detection of hydrogen peroxide [Analytica Chimica Acta 2011, 693, 114-120]. The modified electrode detects hydrogen peroxide in the presence of carboxylic acid. The modified electrode has a detection range of 12.5 μM˜5.0 mM, with a sensitivity of 419.4 μA/mM·cm², and a response time of 6.3 seconds.

The inventors of the present invention have also published electrode sensors to detect H₂O₂ by modifying Au (gold) electrodes with poly(amic acid-benzothiazole) (PAA-BT), poly(amic acid-benzoxazole) (PAA-BO), poly(amide-benzoxazole) (PA-BT) or poly(amide-benzothiazole) (PA-BO) (Biomaterial, 2011, 32, 4885-4895). These modified Au electrodes can detect H₂O₂ in the presence of acetic acid. PAA-BT-modified Au electrode has a sensitivity of 280.6 μA/mM·cm², 0.025 mM to 5.0 mM detection range, and a response time of 5.2 seconds. PAA-BO-modified Au electrode has a sensitivity of 311.2 μA/mM·cm², 0.025 mM to 2.5 mM detection range, and a response time of 3.9 seconds.

Accordingly, the detection of hydrogen peroxide and other analytes of interest using an electrochemical device would be ideal when the detection thereof occurs at reduction potential to prevent detection of undesired analytes. In addition, the electrochemical device should have a short response time and high sensitivity.

### SUMMARY OF THE INVENTION

Therefore, an object of the present invention is to provide an electrode for an electrochemical device that can be used to detect H₂O₂ under reduction potential and that has short response time and high sensitivity.

According to a first aspect of the present invention, an electrode for an electrochemical device comprises:

a conductor; and

an active layer that is formed on the conductor and that includes a polymer having a functional group represented by the following formula (A) or (B) and a carboxylated material containing a carboxylic acid group;

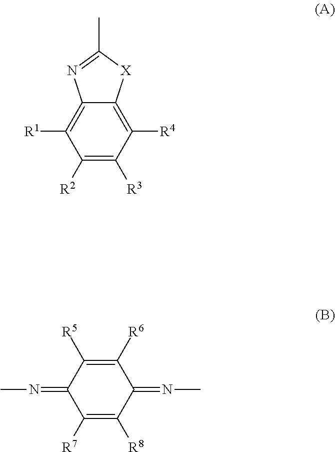

wherein in formula (A), X is O or S; R¹, R², R³ and R⁴ are independently hydrogen, a C₁ to C₁₂ alkyl group, a C₁ to C₁₂ alkoxy group, an ether group, a cycloalkoxy group, a halogen group, a halogenalkyl group, a hydroxyl group, a trifluoromethoxy group, a trimethylflouro group, or a phenyl group;

wherein in formula (B), R⁵, R⁶, R⁷ and R⁸ are independently hydrogen, a C₁ to C₁₂ alkyl group, a C₁ to C₁₂ alkoxy group, an ether group, a cycloalkoxy group, a halogen group, a halogenalkyl group, a hydroxyl group a trifluoromethoxy group, a trimethylflouro group, or a phenyl group; and

wherein the carboxylated material is selected from the group consisting of a carboxylic acid-containing water-soluble polymer, a carboxylated carbon material, and the combination thereof.

According to a second aspect of the present invention, a method for detecting hydrogen peroxide includes the steps of:

contacting a test sample with an electrode of claim 1 such that nitrogen on the functional group of the polymer of the active layer on the electrode is oxidized;

applying a constant voltage to the electrode to reduce the oxidized nitrogen of the polymer of the active layer such that an electrical current is generated; and

measuring the electrical current.

According to a third aspect of the present invention, a method for detecting an analyte includes the steps of:

contacting a test sample with an electrode of claim 1, in the presence of an oxidase, such that nitrogen on the functional group of the polymer of the active layer on the electrode is oxidized;

applying a constant voltage to the electrode to reduce the oxidized nitrogen of the polymer of the active layer such that an electrical current is generated; and measuring the electrical current.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 shows scanning electron microscope (SEM) images of polyaniline-polyacrylic acid/Au electrodes obtained from Examples 1-1 to 1-3, from left to right being Examples 1-1 to 1-3 respectively;

FIG. 2 shows plots of current vs. time of H₂O₂ measured using electrodes of Examples 1-1 to 1-3 respectively. Inset: enlarged plot for a square region circumscribed by dashed lines;

FIG. 3 shows plots of response current vs. concentration of H₂O₂ using electrodes of Examples 1-1 to 1-3. Linear dependence of the response currents upon H₂O₂ concentrations for Examples 1-1 to 1-3 are shown as lines (a) to (c) respectively;

FIG. 4 shows the influence of interfering species, 1 mM uric acid and 1 mM ascorbic acid, on the response current of the electrode of Example 1-2 after addition of 1 mM H₂O₂ in PBS at pH 7.0;

FIG. 5 shows the stability of the electrode of Example 1-2 at different given time points;

FIG. 6 shows a plot of current vs. time using an electrode of Examples 2-1 to 2-5. Curves (a) to (e) indicate electrodes from Examples 2-1 to 2-5 respectively;

FIG. 7 shows a plot of response current vs. H₂O₂ concentration using electrodes of Examples 2-1 to 2-5. Curves (a) to (e) indicate electrodes from Examples 2-1 to 2-5 respectively;

FIG. 8 shows plots of current vs. time and of response current vs. glucose concentration (inset) using an electrochemical sensor containing an electrode of each of Examples 2-6 and 2-7, the electrodes having glucose oxidase. Curves (a) and (b) indicate electrodes from Examples 2-6 and 2-7 respectively;

FIG. 9 shows plots of current vs. time and of response current vs. H₂O₂ concentration (inset) using electrodes of Examples 3 and 4. Curves (a) and (b) indicate electrodes from Examples 3 and 4 respectively;

FIG. 10 shows plots of current vs. time and response current vs. H₂O₂ concentration (inset) using an electrochemical sensor containing electrodes of Examples 5-1 to 5-3. Curves (a) to (c) indicate electrodes of Examples 5-1 to 5-3 respectively;

FIG. 11 shows plots of current vs. time and response current vs. H₂O₂ concentration (inset) using an electrochemical sensor containing an electrode of Examples 6-1 to 6-4. Curves (a) to (d) indicate electrodes of Examples 6-1 to 6-4 respectively; and

FIG. 12 shows plots of current vs. time and response current vs. glucose concentration (inset) using an electrochemical sensor containing an electrode of Example 7. Curves from bottom to top indicate successive increase in glucose concentration, which indicate 0, 0.01, 0.022, 0.1, 0.2, 0.54, 1, 3.5, 5.5 and 7 mM respectively.

### DETAILED DESCRIPTION OF THE PREFERRED EMBODIMENTS

This invention provides an electrode for an electrochemical device, which comprises:

a conductor; and

an active layer that is formed on the conductor and that includes a polymer with a functional group represented by the following formula (A) or (B) and a carboxylated material containing a carboxylic acid group.

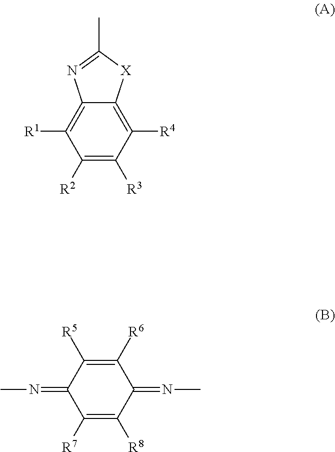

In formula (A), X is O or S; R¹, R², R³ and R⁴ are independently hydrogen, a C₁ to C₁₂ alkyl group, a C₁ to C₁₂ alkoxy group, an ether group, a cycloalkoxy group, a halogen group, a halogenalkyl group, a hydroxyl group, a trifluoromethoxy group, a trimethylflouro group, or a phenyl group.

In formula (B), R⁵, R⁶, R⁷ and R⁸ are independently hydrogen, a C₁ to C₁₂ alkyl group, a C₁ to C₁₂alkoxy group, an ether group, a cycloalkoxy group, a halogen group, a halogenalkyl group, a hydroxyl group, a trifluoromethoxy group, a trimethylfluoro group, or a phenyl group.

The conductor for the electrode can be any materials that have conductivity. In a preferred embodiment of this invention, the conductor is gold (Au) electrode.

The carboxylated material is selected from the group consisting of a carboxylic acid-containing water-soluble polymer, a carboxylated carbon material, and the combination thereof.

The carboxyl acid group of the carboxylated material would react with hydrogen peroxide (H₂O₂).

Materials that have a carboxyl acid group, that consist of a plurality of pores and that do not affect the conductivity of the conductor can be used as the carboxylated carbon material of this invention. The pores can increase the surface area of the active layer.

The carboxylated carbon material is selected from the group consisting of carboxylated carbon tube, carboxylated graphene, carboxylated carbon spheres, and combinations thereof.

Examples of the carboxylated graphene include 1-keto-2-vinyl-butyric acid graphene and 1-keto-2-butyric acid graphene.

Since the carboxylic acid-containing water-soluble polymer is water soluble, certain carboxylic acid-containing water-soluble polymer would be dissolved in water, thus rendering the formation of pores in the active layer. Examples of the carboxylic acid-containing water-soluble polymer include, but are not limited to, polyacrylic acid, poly (2-ethylacrylic acid), poly(2,6-dihydroxymethyl-4-methylphenol-co-4-hydroxy benzoic acid), poly(acrylic acid-co-maleic acid), poly(styrene-co-methacrylic acid), and combinations thereof.

Preferably, the molecular weight of the carboxylic acid-containing water-soluble polymer is in the range of 2,000 to 3,000,000.

Preferably, the molecular weight of the polymer having the functional group (A) or (B) is in the range of 3,000 to 400,000.

The polymer with the functional group of formula (A) is selected from the group consisting of polyamic acid and polyamide derivatives, and has a repeating unit represented by the following formula (I), II), or (III).

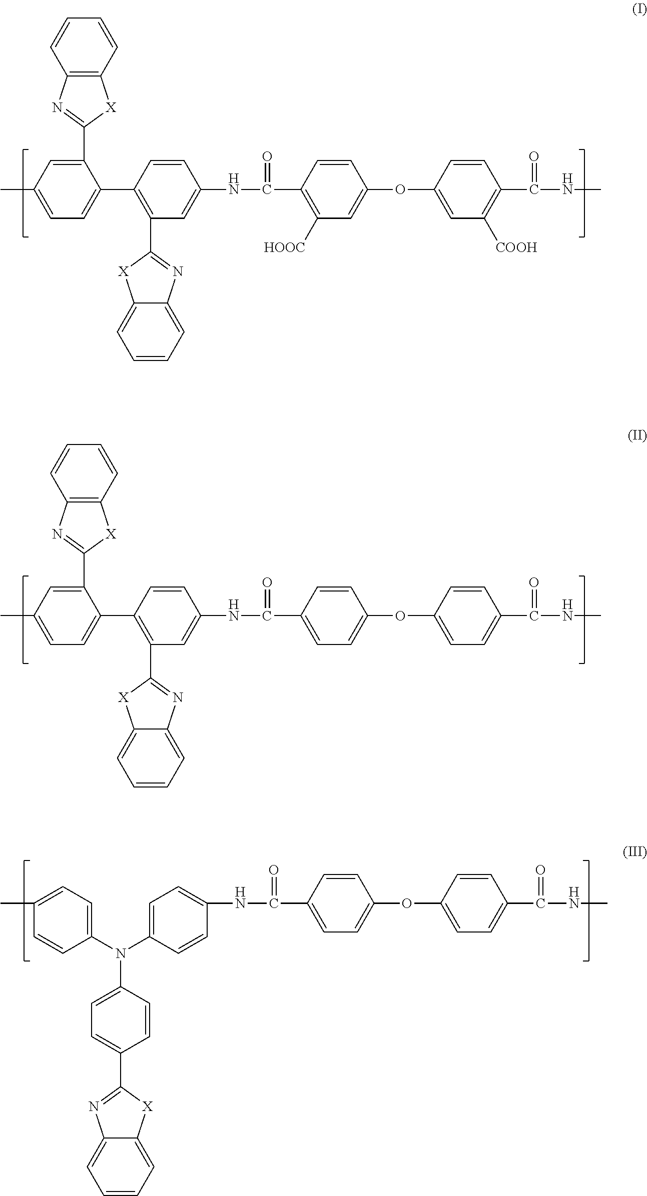

In formula (I), (II), and (III), X is independently O or S.

In formula (I), when X is O, the polymer is poly(amic acid-benzoxazole) (PAA-BO). When X is S, the polymer is poly(amic acid-benzothiazole) (PAA-BT).

In formula (II), when X is O, the polymer is poly(amide-benzoxazole) (PA1-BO). When X is S, the polymer is poly(amide-benzothiazole) (PA1-BT).

In formula (III), when X is O, the polymer is poly(amide-benzoxazole) (PA2-BO). When X is S, the polymer is poly(amide-benzothiazole) (PA2-BT).

In examples of this invention, the active layer includes PAA-BO, PA1-BO, PA1-BT or PA2-BT.

The polymer with the functional group of formula (B) is a polyanline derivative. The polyaniline derivative has a first repeating unit represented by the following formula (PAn-1):

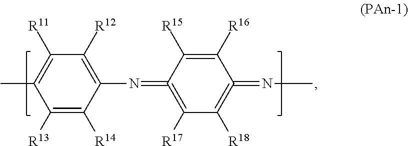

wherein R¹¹, R¹², R¹³, R¹⁴, R¹⁵, R¹⁶, R¹⁷ and R¹⁸ in each occurrence are independently hydrogen, a C₁ to C₁₂ alkyl group, a C₁ to C₁₂ alkoxyl group, an oxygen group, a cycloalkoxy group, a halogen group, a halogenalkyl group, a hydroxyl group, a trifluoromethoxy group, a trimethylflouro group, or a phenyl group.

The polyaniline further includes a second repeating unit represented by the following formula (PAn-2)

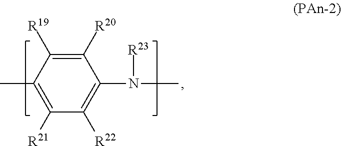

wherein R¹⁹, R²⁰, R²¹, R²² and R²³ in each occurrence are independently hydrogen, a C₁ to C₁₂ alkyl group, a C₁ to C₁₂ alkoxy group, an oxygen group, a cycloalkoxy group, a halogen group, a halogenalkyl group, a hydroxyl group, a trifluoromethoxy group, a trimethylflouro group, or a phenyl group.

The polyaniline derivative containing the first and second repeating units, (PAn-1) and (PAn-2), is used in an example of this invention.

Preferably, the weight ratio of the polymer to the carboxylated material ranges from 1:0.1 to 1:130.

The electrode of this invention can be made by well known methods. For example, the electrode can be made by applying a solution prepared by mixing a diamine polymer and a carboxylated material on a conductor, followed by drying in an oven. Application of the solution on the conductor can be conducted by coating or dripping the solution on the conductor or dipping the electrode into the solution.

The electrode of this invention can be assembled into an electrochemical device with other components, e.g., a counter electrode, a reference electrode, a buffer, an ammeter, and any elements used for an electrochemical device known to those skilled in the art.

This invention also provides a method for detecting hydrogen peroxide, which includes the steps of: contacting a test sample with the electrode such that nitrogen on the functional group of the polymer of the active layer on the electrode is oxidized; applying a constant voltage to the electrode to reduce the oxidized nitrogen of the polymer of the active layer such that an electrical current is generated; and measuring the electrical current.

Specifically, a three-step mechanism by which the electrochemical device detects H₂O₂ is proposed:
1. H₂O₂ chemically oxidizes the carboxylated material to form peroxy acid:
   H₂O₂+carboxylated material→peroxy acid
2. The peroxy acid chemically oxidizes imine group of the polymer to form imine-N-oxide on the polymer:
   peroxy acid+imine group of the polymer→imine-N-oxide on the polymer
3. The imine-N-oxide reverts to an imine group on the polymer by electrochemical reduction:
   imine-N-oxide+H⁺+e⁻→imine group on the polymer

Preferably, the constant voltage is −0.4 V or −0.5 V.

Preferably, the aforementioned electrode can detect H₂O₂ in the presence of an organic acid. Examples of the organic acids include acrylic acid, acetic acid, formic acid, maleic acid, succinic acid, oxalic acid, citric acid, tartaric acid, lactic acid, and malic acid.

The current invention also provides a method for detecting an analyte, which comprises: contacting a test sample with an electrode in the presence of an oxidase, thereby oxidizing the nitrogen on the functional group of the polymer of the active layer on the electrode; applying a constant voltage to the electrode to reduce the oxidized nitrogen of the polymer of the active layer such that an electrical current is generated; and measuring the electrical current.

Specifically, the proposed mechanism is similar to that of detecting H₂O₂, except that, the detection of the analytes of interest requires a suitable oxidase to oxidize the analytes thereby forming H₂O₂. The proposed mechanism is as follows:
1. Analyte of interest+oxidase suitable for the corresponding analyte→H₂O₂
2. H₂O₂+carboxylated material→peroxy acid
3. peroxy acid+imine group of the polymer→imine-N-oxide on the polymer
4. imine-N-oxide+H⁺+e⁻→imine group on the polymer

Preferably, the analyte is selected from the group consisting of glucose, cysteine, hypoxanthine, lactic acid, sterigmatocystin, glutamate, choline and cholesterol.

The oxidase is chosen according to the analyte of interest. Preferably, the oxidase is selected from the group consisting of glucose oxidase, copper/zinc superoxide dismutase, hypoxanthine oxidase, lactate oxidase, aflatoxin-oxidase, glutamate oxidase, choline oxidase and cholesterol oxidase.

Preferably, the oxidase is fixed on the electrode.

Preferably, the electrode of the present invention can detect the aforementioned analytes in the presence of an organic acid. Examples of the organic acid include acrylic acid, acetic acid, formic acid, maleic acid, succinic acid, oxalic acid, citric acid, tartaric acid, lactic acid, and malic acid.

### EXAMPLES

### <Source of Chemicals>

1. Polyaniline: synthesized according to J. Am. Chem. Soc. 2004, 126, 851-855, molecular weight: 12,000.
2. Polyacrylic acid: purchased from Showa, molecular weight: 280,000.
3. Dimethyl sulfoxide (DMSO): purchased from Tedia.
4. N-Methyl-2-pyrrolidone (NMP): purchased from Tedia.
5. Carboxylated carbon tube: carbon tube was modified with sulfuric acid and nitric acid with a volume ratio of 3:1. Detailed methods are disclosed in polymer 2006, 47, 3576-3582.
6. Carboxylated graphene (Ga-COOH)
   1-keto-2-vinyl-butyric acid graphene was prepared as follows: (1) 50 mg of graphene was placed into 200 mL of NMP, followed by dispersion using an ultrasonic vibrator to obtain a graphene solution; (2) 0.98 g (10 mmol) of maleic anhydride (purchased from Showa Corporation) was dissolved in NMP followed by the gradual addition of 4.08 g (30 mmole) of aluminum chloride, and was mixed using an ultrasonic vibrator for 4 hours at 90° C. to obtain a MA solution; (3) graphene solution was added dropwise into the MA solution that was heated to 160° C., stirred to react for 48 hours and cooled to room temperature; and (4) the mixture obtained in step (3) was filtered through a PVDF membrane with a pore size of 0.1 μm followed by washing with methanol and deionized water to remove NMP and drying, thus obtaining the 1-keto-2-vinyl-butyric acid graphene.
7. poly(amide-benzothiazole) (PA1-BT)
   (1) 2,2′-bis(2-benzothiazole)-4,4′-diaminobipheny 1 (DABPBT) was synthesized based on the method described in Macromolecules, 2008, 41, 9556-64. To synthesize PA1-BT, 0.225 g of DABPBT (0.5 mmol) with 0.129 g of 4,4′-dicarboxydiphenyl ether, 0.1 g of calcium chloride, 0.6 mL of triphenyl phosphite, 0.2 mL of pyridine, and 2.0 mL of NMP were mixed to obtain a reaction solution; (2) the reaction solution was heated with stirring at 120° C. for 4 h, then poured slowly into 200 mL of stirring methanol to obtain a stringy precipitate; (3) the stringy precipitate was collected by filtration, washed thoroughly with hot water and methanol, and dried at 120° C.; and(4) the dried precipitate was reprecipitated twice using N,N-dimethylacetamide (DMAc).
8. poly(amide-benzoxazole) (PA1-BO)
   The method for preparing PA1-BO was similar to that of PA1-BT, except that 0.209 g of 2,2′-bis(2-benzoxoazole)-4,4′-diaminobiphenyl (DABPBO) (0.5 mmol) was used to replace DABPBT.
9. poly(amide-benzothiazole) (PA2-BT)
   The method for preparing PA2-BT was similar to that of PA1-BT, except that 0.204 g of 4-di(2-benzothiazole)-4,4′-diamino-triphenylamine (0.5 mmol) was used to replace DABPBT.
10. polyamic acid-benzoxazole (PAA-BO)
   To synthesize PAA-BO, 2.06 mmole (0.638 g) of 4,4′-oxydiphthalic anhydride were added to a DABPBO/NMP solution (15% w/v, DABPBO: 2.06 mmole, 0862 g) with stirring under N₂ and was allowed to react under N₂ for six hours at room temperature, thus obtaining a resultant product of PAA-BO.

### <Characterization of the Synthesized Chemicals>

1. Characterization of PA1-BT
   To characterize PA1-BT, FT-IR and ¹H NMR were used.
   (1) The FT-IR spectra showed absorptions at 3297 cm⁻¹ (N—H stretching of amide group), and at 1622 cm⁻¹ (C═O stretching of amide group), thus confirming the resultant product as having amide group.
   (2)¹H NMR performed in DMSO-d₆ detected chemical shifts at 7.29-7.50 (10H), 7.95 (4H), 8.19 (6H), 8.86 (2H) and 10.7 (2H, NH), thus confirming successful synthesis of PA1-BT. The inherent viscosity of PA1-BT was 1.45 dL/g at a concentration of 0.5 g/dL in NMP at 30° C.
2. Characterization of PA1-BO
   To characterize PA1-BO, FT-IR and ¹H NMR were used.
   (1) The FT-IR spectra showed absorptions at 3297 cm⁻¹ (N—H stretching of amide group), and at 1622 cm⁻¹ (C═O stretching of amide group), thus confirming the resultant product as having amide group.
   (2)¹H NMR performed in DMSO-d₆ detected chemical shifts at 7.29-7.32 (8H), 7.41 (2H), 7.47 (2H), 7.57 (2H), 8.11-8.19 (6H), 8.68 (2H) and 10.6 (2H, NH), thus confirming successful synthesis of PA1-BO. The inherent viscosity of PA1-BO was 0.96 dL/g at a concentration of 0.5 g/dL in NMP at 30° C.
3. Characterization of PA2-BT
   The dried product was characterized by NMR and FTIR, confirming the obtained product is PA2-BT. The inherent viscosity of PA2-BT was 0.35 dL/g at a concentration of 0.5 g/dL in NMP at 30° C.
4. Characterization of PAA-BO:
   To characterize PAA-BO, FT-IR and ¹H NMR were used.
   (1) The FT-IR spectra showed absorptions at 3300 cm⁻¹ (N—H and O—H stretching of amic acid), and at 1722 cm⁻¹ and 1662 cm⁻¹ (C═O stretching of amic acid), thus confirming the resultant product as having amic acid group.
   (2)¹H NMR performed in DMSO-d₆ detected chemical shifts at 7.23-7.56 (14H), 7.84-8.06 (4H) and 10.9-11.1 (2H, NH), thus confirming successful synthesis of PAA-BO. The inherent viscosity of PAA-BO was 1.02 dL/g at a concentration of 0.5 g/dL in NMP at 30° C.

### <Electrochemical Testing>

An electrochemical device used in the present invention includes the electrode of this invention, a counter electrode, a reference electrode, a buffer, and an ammeter. All electrochemical measurements were performed in 40 mL of 0.2 M phosphate buffered saline (PBS) (pH 7.0) at 25° C.

All measurements were conducted by applying a constant voltage of either −0.4 V or −0.5 V, and stabilized for 150 seconds. Thereafter, current was recorded after various concentrations of H₂O₂ were sequentially added (from low to high) into the electrochemical device.

All measurements were taken when the electrode is responsive to each concentration change with a signal to noise ratio of at least 3. The detection limit and linear range can be extrapolated from plots of current vs. time plot or response current vs. H₂O₂ concentration.

The response time is time interval between the current changes of two adjacent stages.

The sensitivity (μA/mM·cm²) for H₂O₂ was also studied and is a ratio of the slope of the curve of the current vs. H₂O₂ concentration plot to the surface area of the Au electrode.

### Examples 1-1

### Electrodes Having Polyaniline (PAn) and Polyacrylic Acid as the Active Layer

3.62 g (10 mmol) of PAn was dissolved in 50 mL of DMSO to obtain a solution A; and 0.72 g (10 mmol) of polyacrylic acid was dissolved in 50 ml of DMSO to obtain a solution B. 2 ml of solution A and 8 mL of solution B were evenly mixed to form a mixture. 5 μL of the mixture was dripped on an Au electrode having 0.1 cm² of surface area and dried for 24 hours at 30° C. in a vacuum oven, followed by washing with deionized water to remove excess polyacrylic acid. The electrode was dried, thus obtaining an electrode for Example 1-1.

### Examples 1-2 and 1-3

The preparation methods for Examples 1-2 and 1-3 were similar to that of Example 1-1, except that the mixing ratios of solutions A and B are different (see Table 1).

### <Electrochemical Testing of Examples 1-1 to 1-3>

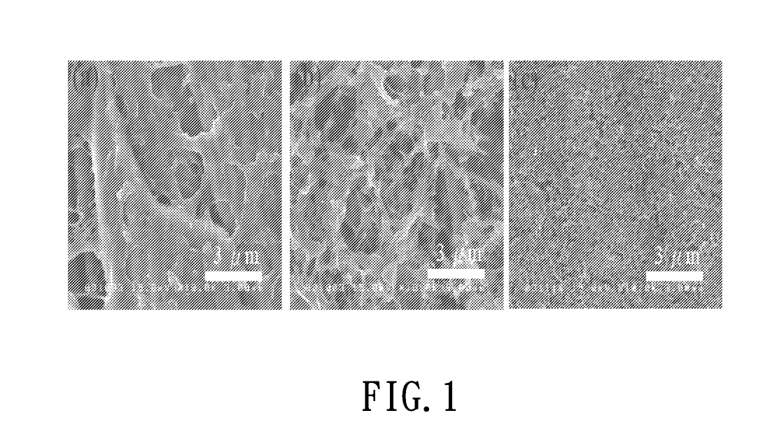

1. Observation of Electrode Surface
Electrodes from Examples 1-1 to 1-3 were observed under a scanning electron microscope (SEM). Images from SEM are shown in FIG. 1. (a), (b) and (c) represent Examples 1-1, 1-2 and 1-3, respectively. From FIG. 1, a plurality of pores are formed in surfaces of the electrodes of Examples 1-1 to 1-3, presumably due to washing out the water-soluble polyacrylic acid, thus forming a porous electrode. The pores thus formed lead to increase in surface area of each of the electrodes.

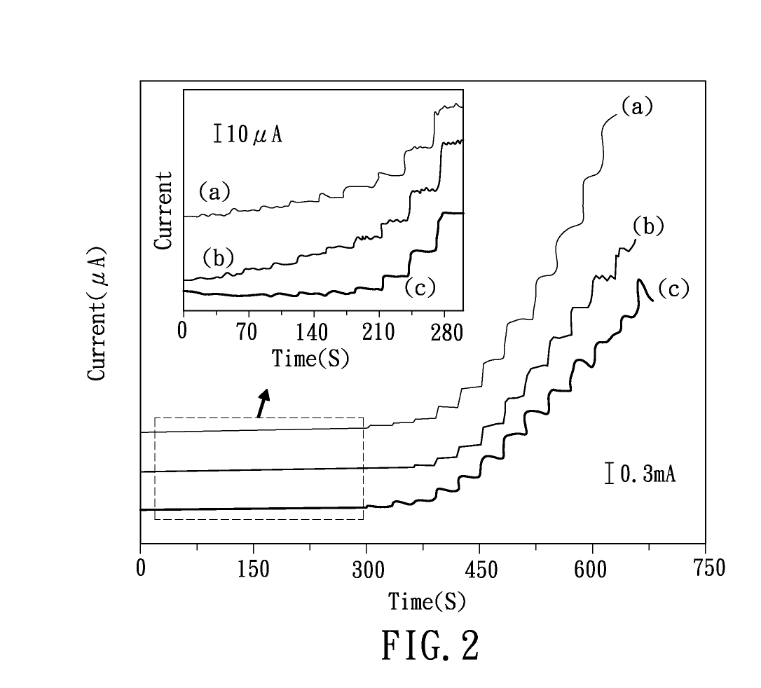

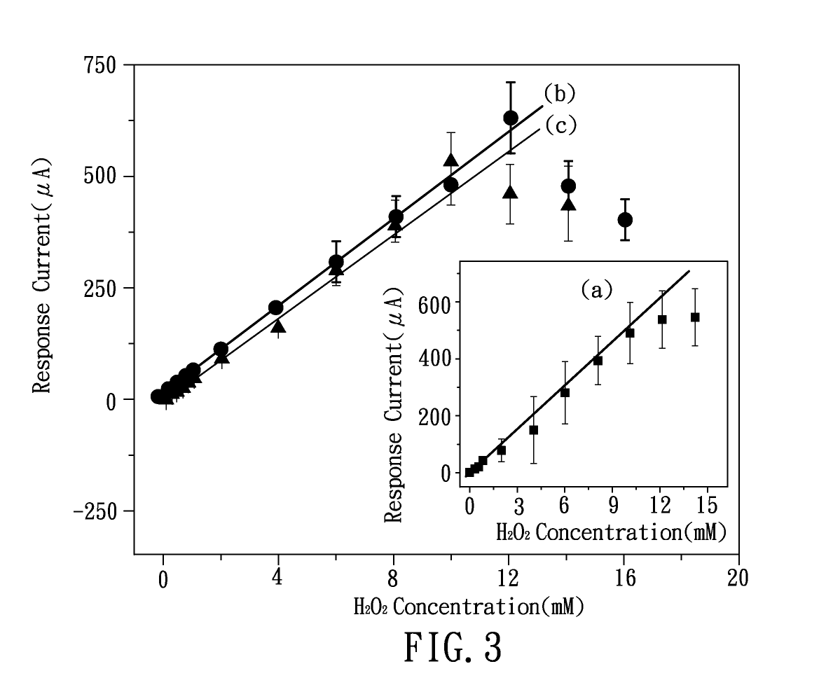

2. Determination of the Effect of Various Concentrations of Hydrogen Peroxide on Response Current
An electrochemical device including each of the electrodes of Examples 1-1 to 1-3, a counter electrode, a reference electrode, a buffer, and an ammeter was used in this test. A constant voltage of −0.5 V was applied to the electrodes obtained from Examples 1-1 to 1-3. After the stabilization of the initial current for 150 seconds, 0.1 mL of various concentrations of H₂O₂ was added to the electrochemical device at an interval of 30 seconds. Specifically, H₂O₂ of various concentrations ranging from 1 mM to 8M were added. The current during the test was recorded, and the relationship between the current and time was plotted and is shown in FIG. 2.
The curves (a), (b) and (c) in FIG. 2 represent the results from electrochemical devices having the electrodes of Examples 1-1, 1-2 and 1-3, respectively. The current shown in curves (a) to (c) increases in response to the concentration of H₂O₂.
Similarly, FIG. 3 is a plot showing the response current vs. H₂O₂ concentration of Examples 1-1, 1-2 and 1-3 represented by curves (a), (b) and (c), respectively. The detection limit is determined by the response current when the electrode is responsive to the lowest concentration of H₂O₂. In addition, linear range and sensitivity can be extrapolated from FIG. 3. The results are shown in Table 1.

TABLE 1

| | Example | | |
|---|---|---|---|
| | 1-1 | 1-2 | 1-3 |
| Volume ratio of solutions A to B | 2/8 | 3/7 | 5/5 |
| Weight ratio of polyaniline to | 1:0.8 | 1:0.46 | 1:0.2 |
| polyacrylic acid | | | |
| Surface area of Au electrode (cm²) | 0.1 | 0.1 | 0.1 |
| Response time (seconds) | 4.98 | 4.76 | 3.18 |
| Sensitivity (μA/mM · cm²) | 553.9 | 417.5 | 379.4 |
| Detection range (mM) | 0.5~12 | 0.04~12 | 0.1~10 |
| Detection limit (mM) | 40 | 20 | 60 |

As shown in Table 1, the response time exhibits an inverse correlation with the amount of polyacrylic acid. The sensitivity also increases with the increase of the amount of polyacrylic acid. This indicates that the polyacrylic acid promotes the oxidation of polyaniline and increases the responsiveness to the reductive current.

3. Interference

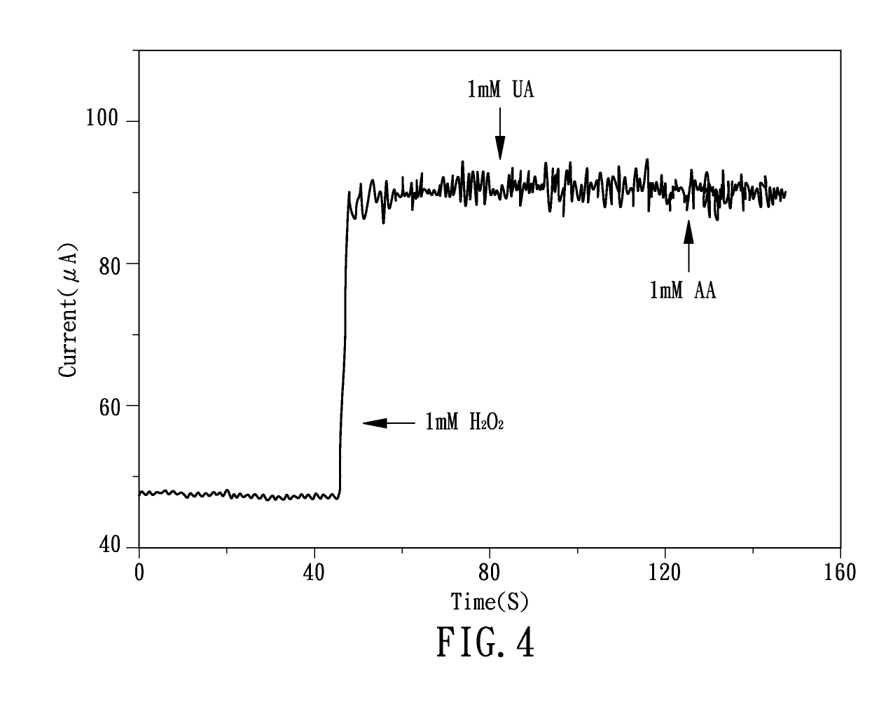

−0.5 V was applied to the electrochemical device having the electrode of Example 1-2 and the current was stabilized for 150 seconds. 1 mM of H₂O₂ solution was added into the electrochemical device. After the stabilization of the current, different interfering molecules were added at intervals of 40 seconds. Specifically, 1.0 mM of ascorbic acid (AA) and 1.0 mM of uric acid (AA), both in PBS, were added sequentially into the electrochemical device. The results are shown in FIG. 4.

As shown in FIG. 4, the current was not affected by the addition of interfering molecules, thus suggesting the specificity of the electrode of this invention.

4. Determination of Stability of the Electrode

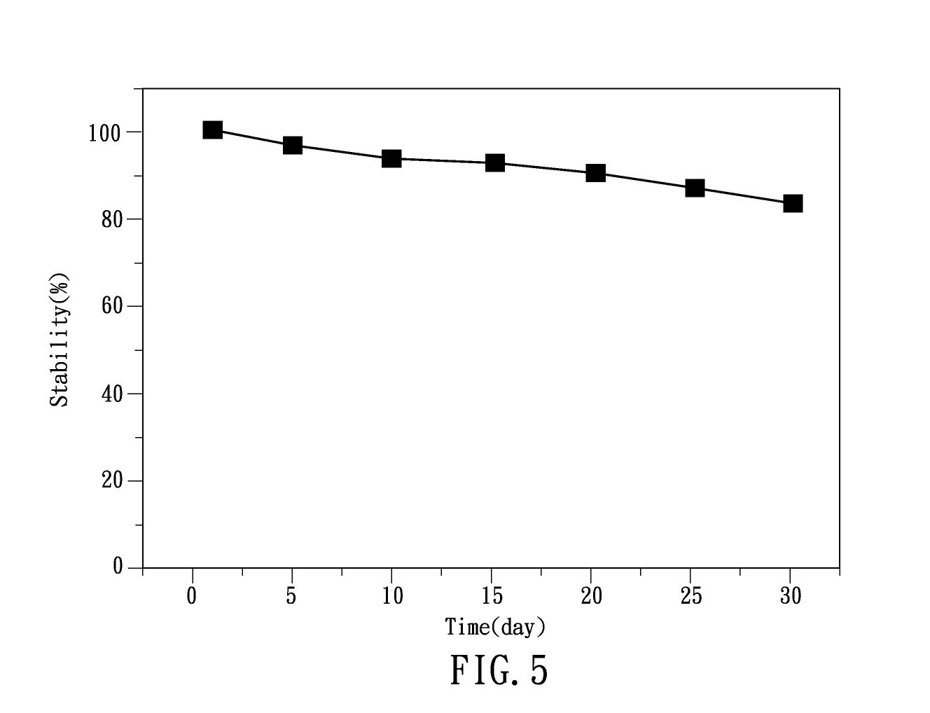

The stability of the electrode is defined as the percentage change of the electrical output (current) between a given time point during the exposure to an environment of interest to that before the exposure to the environment of interest. The electrochemical device containing the electrode of Example 1-2 was preserved under 30° C. As shown in FIG. 5, the initial response current of the electrochemical device to 1 mM of H₂O₂ was 41.7 μA. The response current to 1 mM of H₂O₂ was recorded at day 5, 10, 15, 20, 25 and 30 to determine the stability of the electrochemical device. At day 30, the response current of the electrochemical device in the presence of 1 mM of H₂O₂ was 34.9 μA, which was 83.6% of its initial response current (34.9/41.7×100%=83.6%). These results demonstrate good stability of the electrode.

### Examples 2-1 to 2-5

### Electrodes Having an Active Layer Composed of Polyaniline and Carboxylated Graphene (Ga-COOH)

1.5 mg (4×10⁻³ mmol) of polyaniline was dissolved in 1 mL of DMSO to obtain a solution A. 10 mg of carboxylated graphene (Ga-COOH) was dissolved in 1 mL of DMSO to obtain a solution B. 0.05 mL of the solution A and 0.95 mL of the solution B were evenly mixed, followed by addition of 13.5 mL of DMSO to obtain a mixed solution. 5 μL of the mixed solution was evenly coated on a Au electrode (with 0.0415 cm² surface area) followed by drying in a vacuum oven at 30° C. for 12 hours, thus obtaining an electrode of Example 2-1. The electrode contains a porous active layer composed of polyaniline and Ga-COOH.

The preparation methods for Examples 2-2 to 2-5 were similar to that of Example 1-1, except that the mixing ratios of solutions A and B, and the volume of DMSO were different (see Table 2).

### <Electrochemical Testing of Examples 2-1 to 2-5>

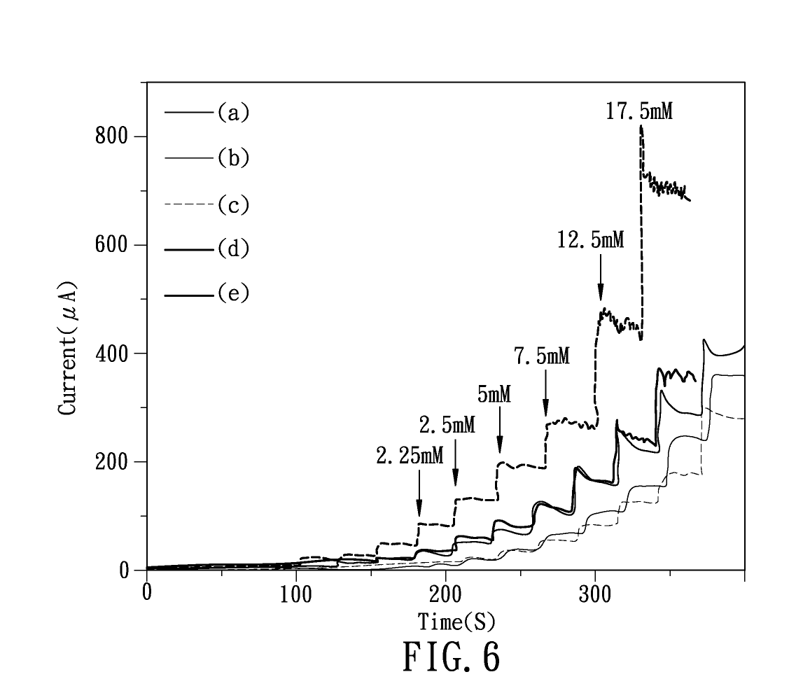

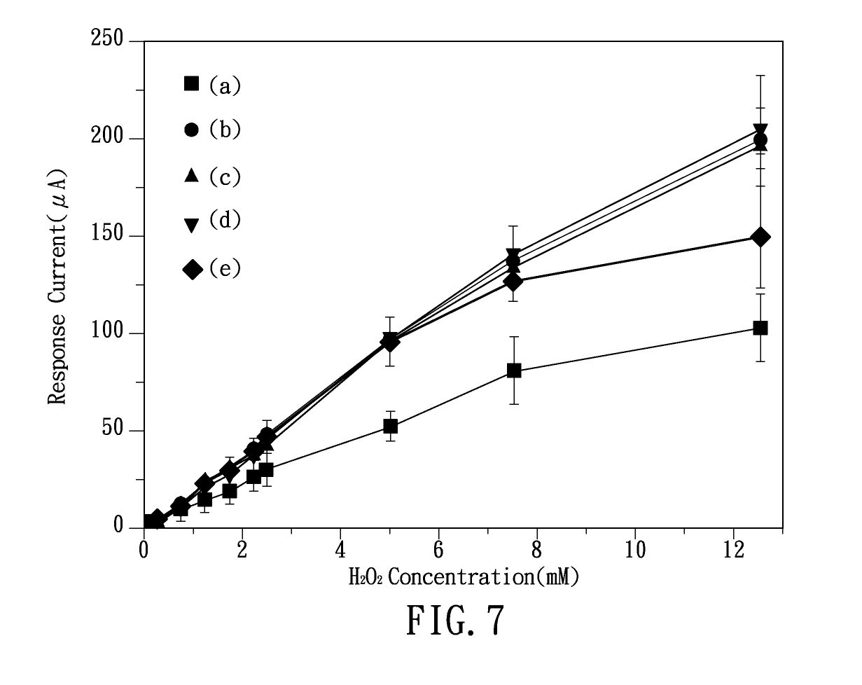

The electrochemical testings in Examples 2-1 to 2-5 were similar to those in Examples 1-1 to 1-5, except that a constant voltage of −0.4 V was applied to the electrochemical device. FIG. 6 is a plot showing the time vs. response current when various concentrations of H₂O₂ were added. Curves (a) to (e) represent results of the electrode obtained from Examples 2-1 to 2-5, respectively. In FIG. 6, in each curve, the current is increased with the increase of the concentration of the H₂O₂ solution. Similarly, FIG. 7 is a plot showing the response current vs. H₂O₂ concentration. The detection limit, linear range and sensitivity can be extrapolated from FIG. 7. The results are shown in Table 2.

TABLE 2

| | Example | | | | |
|---|---|---|---|---|---|
| | 2-1 | 2-2 | 2-3 | 2-4 | 2-5 |
| Volume ratio | 0.05/0.95 | 0.1/0.9 | 0.2/0.8 | 0.3/0.7 | 0.4/0.6 |
| of solutions A to B | | | | | |
| Weight ratio of | 1:127 | 1:60 | 1:27 | 1:16 | 1:10 |
| polyaniline to | | | | | |
| carboxylated | | | | | |
| graphene | | | | | |
| Volume of | 13.5 | 12.9 | 11.6 | 10.3 | 9 |
| DMSO (mL) | | | | | |
| Surface area | 0.0415 | 0.0415 | 0.0415 | 0.0415 | 0.0415 |
| of Au electrode | | | | | |
| (cm²) | | | | | |
| Response time | 4.4 | 5.2 | 5.8 | 4.7 | 4.8 |
| (seconds) | | | | | |
| Sensitivity | 262 | 455 | 441 | 410 | 400 |
| (μA/mM · cm²) | | | | | |
| Detection | 0.125~7.5 | 0.025~12.5 | 0.0225~7.5 | 0.075~12.5 | 0.075~7.5 |
| range (mM) | | | | | |
| Detection | 82 | 15 | 16 | 18 | 36 |
| limit (mM) | | | | | |

As shown in Table 2, the addition of Ga-COOH promotes the oxidation of polyaniline and increases the responsiveness to reductive current.

### Examples 2-6 and 2-7

### Electrodes Having an Active Layer Composed of Polyaniline, Carboxylated Graphene (Ga-COOH), and Glucose Oxidase

1.5 mg (4×10⁻³ mmol) of polyaniline was dissolved in 1 mL of DMSO to obtain a solution A. 10 mg of Ga-COOH was dissolved in 1 mL of DMSO to obtain a solution B. 0.4 mL of solution A and 0.6 mL of solution B were evenly mixed, followed by adding 10.3 mL of deionized water and even mixing using an ultrasonic vibrator to obtain a mixture containing a precipitate of polyaniline-encapsulated Ga-COOH. 10 mg of glucose oxidase (purchased from Sigma-Aldrich) was added into the mixture, and adsorption of glucose oxidase onto the precipitate was allowed for three hours at 4° C. Thereafter, centrifugation was performed to remove excess un-adsorbed glucose oxidase to obtain the precipitate with glucose oxidase. 11.3 mL of deionized water was added to the precipitate with glucose oxidase to form a solution C. 5 μL of solution C was dripped onto an Au electrode having a surface area of 0.0415 cm². The Au electrode was dried in a vacuum oven at room temperature for 10 minutes, thus obtaining an electrode of Example 2-6. The electrode comprises an active layer having polyaniline, Ga-COOH, and glucose oxidase.

The preparation method for Example 2-7 was similar to that of Example 2-6, except that in Example 2-7, 0.3 mL of solution A and 0.7 mL of solution B were mixed with 9 mL of deionized water. Thereafter, 10 mL of deionized water was used to dissolve the precipitate to obtain the solution C. The parameters for preparing the electrodes of Examples 2-6 and 2-7 are listed in Table 3.

### <Electrochemical Testing of Examples 2-6 to 2-7>

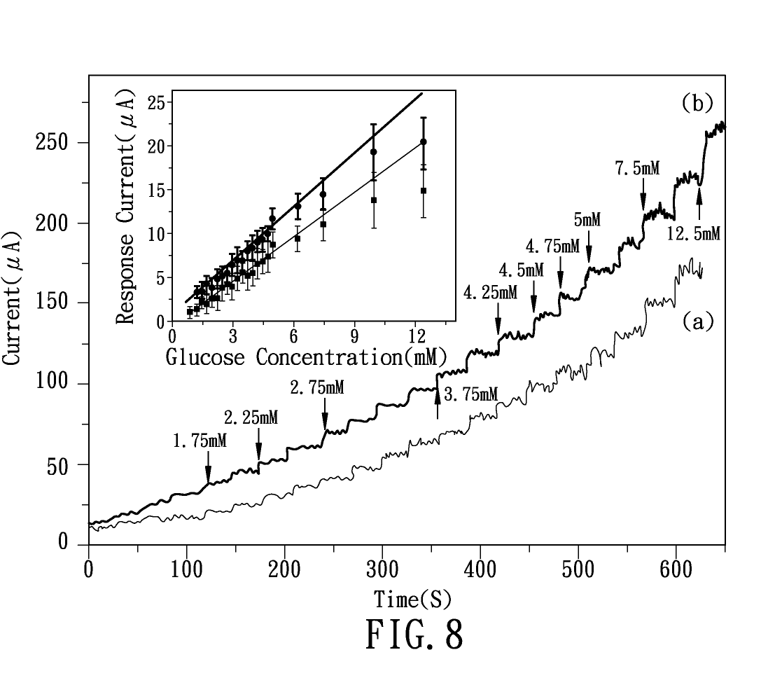

Various concentrations of glucose solution ranging from 1 mM to 5 M were prepared. A constant voltage of −0.4 V was applied to the electrode and stabilized for 150 seconds. Thereafter, 0.1 mL of various concentrations of solution C was added to the electrochemical device at intervals of 30 seconds. The results are shown in FIG. 8, in which a plot of current vs. time is shown. Curves (a) and (b) indicate the current vs. time of Electrodes 2-6 and 2-7, respectively. The inset of FIG. 8 is a plot showing the response current vs. glucose concentration. The response time, detection limit, linear detection range, and sensitivity can be extrapolated from FIG. 8 and are listed in Table 3.

TABLE 3

Example

| | 2-6 | 2-7 |
|---|---|---|
| Volume ratio of solutions A to B | 0.4/0.6 | 0.3/0.7 |
| Weight ratio of polyaniline to | 1:10 | 1:16 |
| carboxylated graphene | | |
| Volume of deionized water (mL) | 10.3 | 9 |
| Surface area of Au electrode (cm²) | 0.0415 | 0.0415 |
| Response time (seconds) | 9.1 | 9.4 |
| Sensitivity (μA/mM · cm²) | 27.08 | 21.79 |
| Detection range (mM) | 1~10 | 1.25~10 |
| Detection limit (mM) | 0.331 | 0.477 |

As shown in Table 3, the response time and sensitivity are better in the electrode obtained from Example 2-6.

### Example 3

### Electrode Having an Active Layer Composed Of Poly(Amide-Benzothiazole) (PA1-BT) and Carboxylated Graphene (Ga-COOH)

2 mg of PA1-BT was dissolved in 5 mL of NMP to obtain a solution A. 2 mg of Ga-COOH was dissolved in 5 mL of NMP to obtain a solution B. 0.5 mL of solution A and 0.5 mL of solution B were evenly mixed to obtain a mixture. 5 μL of the mixture was dripped onto an Au electrode with a surface area of 0.07 cm², followed by drying in a vacuum oven at 50° C. for 24 hours. An electrode with an active layer composed of PA1-BT/Ga-COOH was thus obtained.

### Example 4

### Electrode Having an Active Layer Composed of Poly(Amide-Benzoxazole)(PA1-BO) and Carboxylated Graphene (Ga-COOH)

The preparation method for an electrode composed of PA1-BT and Ga-COOH was similar to that of Example 3, except that PA1-BT was substituted with PA1-BO.

### <Electrochemical Testing of Examples 3 to 4>

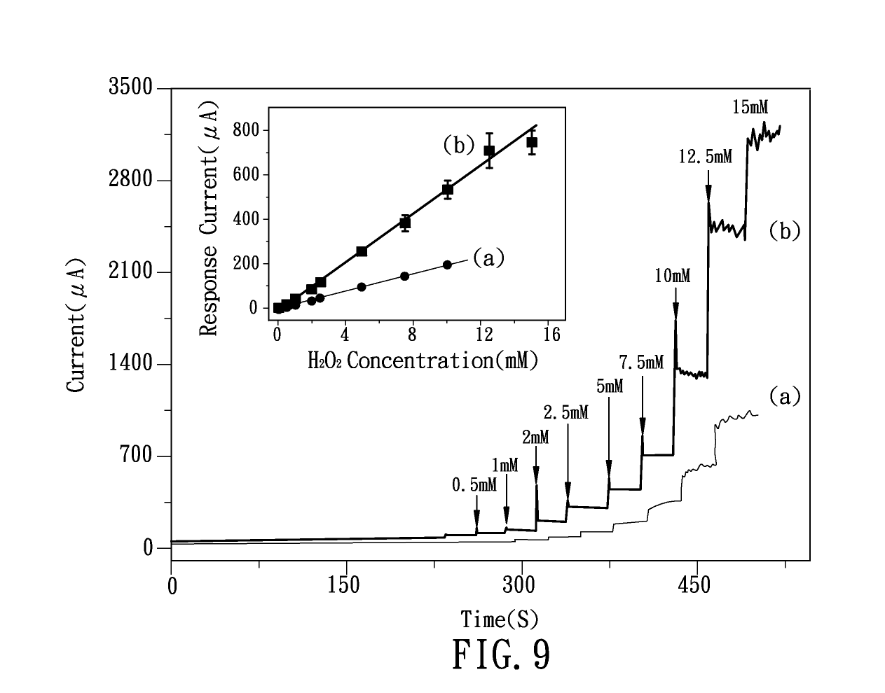

Various concentrations of H₂O₂ ranging from 1 mM to 8 M were prepared. A constant voltage of −0.5 V was applied to the electrodes from Examples 3 and 4 and stabilized for 150 seconds. Thereafter, 0.1 mL of various concentrations of H₂O₂ were added to the electrochemical device at intervals of 30 seconds, and the response current was recorded. FIG. 9 is a current-time plot showing the response current of electrodes from Examples 3 and 4, shown as curves (a) and (b), respectively.

The inset of FIG. 9 shows a H₂O₂ concentration vs. response current plot. Curves (a) and (b) represent electrodes from Examples 3 and 4, respectively. The detection limit, linear range and sensitivity can be extrapolated from FIG. 9 and are listed in Table 4.

TABLE 4

Example

| | 3 | 4 |
|---|---|---|
| Volume ratio of | 0.5/0.5 | 0.5/0.5 |
| solutions A to B | | |
| Weight ratio of PA-BT | 1:1 | 1:1 |
| or PA-BO to | | |
| carboxylated graphene | | |
| Surface area of Au | 0.07 | 0.07 |
| electrode (cm²) | | |
| Response time | 3.8 | 2.1 |
| (seconds) | | |
| Sensitivity | 278.4 | 761.4 |
| (μA/mM · cm²) | | |
| Detection range (mM) | 0.05~10 | 0.025~12.5 |
| Detection limit (mM) | 19.4 | 6.7 |

As shown in Table 4, the response time and sensitivity are better in the electrode obtained from Example 4.

### Examples 5-1 to 5-3

### Electrode Having Active Layer Composed of Poly(Amide-Benzothiazole) (PA2-BT) and Polyacrylic Acid

0.618 g (1 mmol) of PA2-BT was dissolved in 10 ml of DMSO to obtain a solution A. 0.072 g (1 mmol) of polyacrylic acid was dissolved in 10 mL of DMSO to obtain a solution B. 0.1 mL of the solution A and 0.9 mL of the solution B were evenly mixed to obtain a mixture. 5 μL of the mixture was dripped onto an Au electrode having a surface area of 0.057 cm², followed by drying in a vacuum oven at 30° C. for 24 hours. The electrode was washed with deionized water to remove excess polyacrylic acid and dried, thus obtaining an electrode of Example 5-1.

Preparation methods for Examples 5-2 and 5-3 were similar to that of Example 5-1, except that the mixing ratios of the solutions A and B were different, and are listed in Table 5.

### <Electrochemical Testing of Examples 5-1 to 5-3>

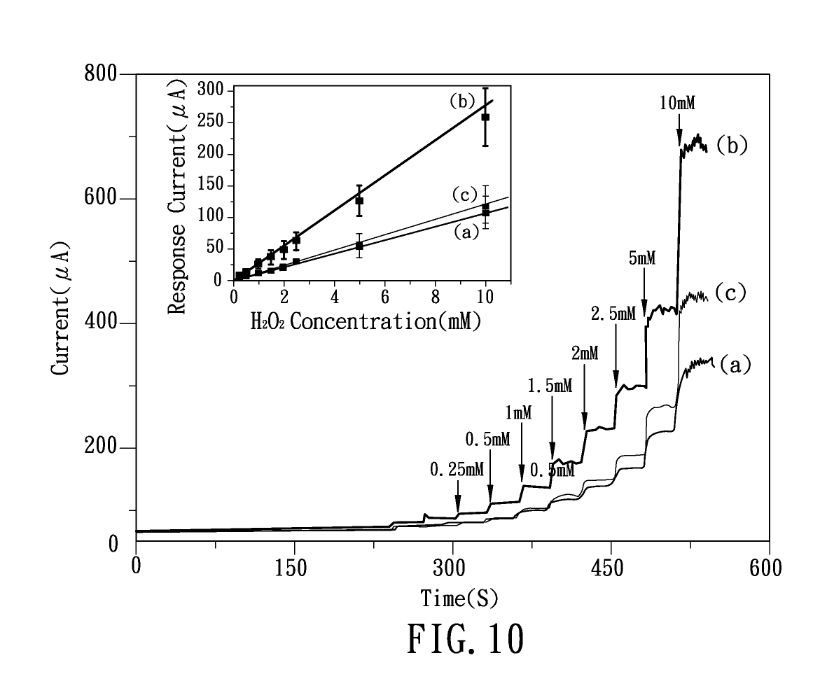

Similar to the testing conducted in Examples 3 and 4, various concentrations of H₂O₂ were added to the electrochemical device. FIG. 10 and inset show a plot of current vs. time and H₂O₂ concentration vs. response current, respectively. Curves (a) to (c) represent electrodes from Examples 5-1 to 5-3 respectively. The response time, detection limit, linear range and sensitivity are listed in Table 5.

TABLE 5

| | Example | | |
|---|---|---|---|
| | 5-1 | 5-2 | 5-3 |
| Volume ratio of | 0.1/0.9 | 0.2/0.8 | 0.5/0.5 |
| solutions | | | |
| A to B | | | |
| Weight ratio of PA2-BT | 1:1.05 | 1:0.47 | 1:0.12 |
| to polyacrylic acid | | | |
| Surface area of Au | 0.057 | 0.057 | 0.057 |
| electrode (cm²) | | | |
| Response time | 4.6 | 3.8 | 5.9 |
| (seconds) | | | |
| Sensitivity | 178.1 | 469.5 | 195.5 |
| (μA/mM · cm²) | | | |
| Detection range (mM) | 0.025~10 | 0.025~10 | 0.05~10 |
| Detection limit (mM) | 25 | 25 | 50 |

As shown in Table 5, the electrode from Example 5-2 has a shorter response time and higher sensitivity.

### Examples 6-1 to 6-4

### Electrode Having an Active Layer Composed of Polyamic Acid-Poly(Amide-Benzoxazole) ((PAA)-BO) and Carboxylated Graphene (Ga-COOH)

6 mg of PAA-BO was dissolved in 1 mL of NMP to obtain a solution A. 4 mg of Ga-COOH was dissolved in 1 mL of NMP to obtain a solution B. 40 μl of the solution A, 20 μl of the solution B and 20 μl of NMP were evenly mixed to obtain a mixture. 5 μL of the mixture was dripped onto an Au electrode having a surface area of 0.0616 cm², followed by drying in a vacuum oven at 40° C. for 8 hours, thus obtaining an electrode of Example 6-1.

Preparation methods for Examples 6-2 to 6-4 were similar to that of Example 6-1, except that the mixing ratios of the solutions A and B were different, and are listed in Table 6.

### <Electrochemical Testing of Examples 6-1 to 6-4>

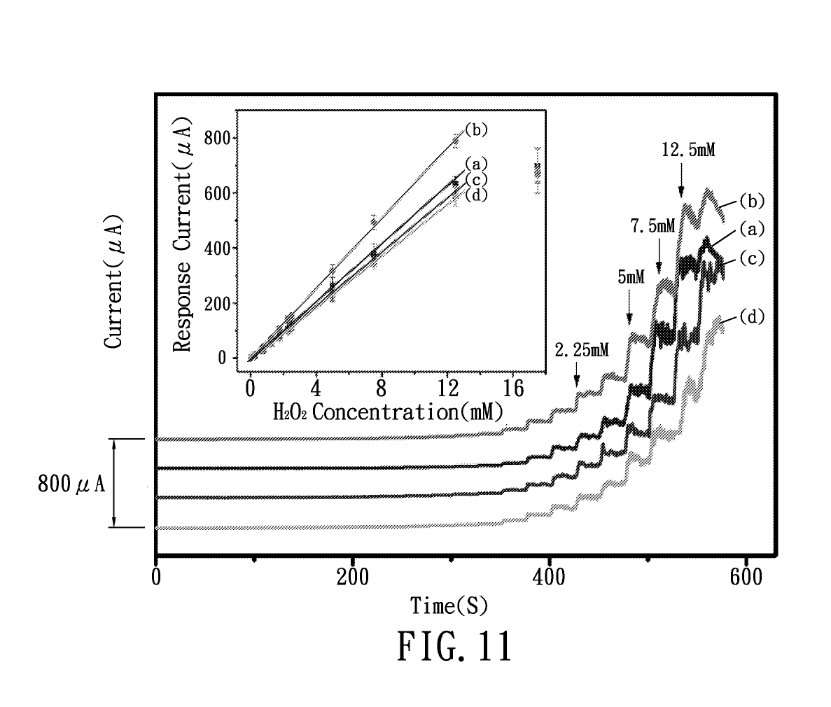

Various concentrations of H₂O₂ ranging from 1 mM to 5M were prepared. A constant voltage of −0.5 V was applied to the electrochemical device and stabilized for 150 seconds. Thereafter, 0.1 mL of various concentrations of H₂O₂ was added thereto at intervals of 25 seconds, and the current was recorded. FIG. 11 and inset are plots of current vs. time and H₂O₂ concentration vs. response current, and curves (a) to (d) represent electrodes from Examples 6-1 to 6-4, respectively. The detection limit, linear range and sensitivity can be extrapolated from the plot shown in FIG. 11 and are listed in Table 6.

TABLE 6

| | Example | | | |
|---|---|---|---|---|
| | 6-1 | 6-2 | 6-3 | 6-4 |
| Volume ratio | 40/20 | 40/80 | 40/240 | 40/320 |
| of solutions | | | | |
| A to B | | | | |
| Weight ratio of | 1:0.33 | 1:1.33 | 1:4 | 1:5.33 |
| PAA-BO to | | | | |
| Ga—COOH | | | | |
| Volume of | 20 | 20 | 20 | 20 |
| NMP (L) | | | | |
| Surface area of | 0.0616 | 0.0616 | 0.0616 | 0.0616 |
| Au electrode | | | | |
| (cm²) | | | | |
| Response time | 1.3 | 2.1 | 2.8 | 2.8 |
| (seconds) | | | | |
| Sensitivity | 845.7 | 1037.6 | 764.6 | 727.5 |
| (μA/mM · cm²) | | | | |
| Detection range | 0.0075~12.5 | 0.0025~12.5 | 0.0075~12.5 | 0.0075~12.5 |
| (mM) | | | | |
| Detection limit | 4 | 2 | 4 | 4 |
| (mM) | | | | |

As shown in Table 6, the electrode from Example 6-1 has the shortest response time (1.3 seconds). The electrode from Example 6-2 has the highest sensitivity (1037.6 μA/mM·cm²) and broadest detection range (0.0025-12.5 mM).

### Examples 7

### Electrode Having an Active Layer Composed of Polyamic Acid-Poly (Amide-Benzoxazole) (PAA)-BO) and Carboxylated Graphene (Ga-COOH)

The preparation method for the electrode of Example 7 was similar to that of Example 6-1, except that, 40 μL of solution A, 80 μL of solution B and 20 μL of NMP were evenly mixed to obtain a mixture.

### <Electrochemical Testing of Example 7>

The electrode from Example 7 was placed in 40 mL of PBS (pH=7) saturated with oxygen, and 170 U of glucose oxidase (purchased from Sigma-Aldrich) was added thereto. An electrochemical device was further setup by connecting the electrode and an ammeter by a wire, and connecting a reference electrode to an ammeter. An electrochemical device for Example 7 was thus obtained.

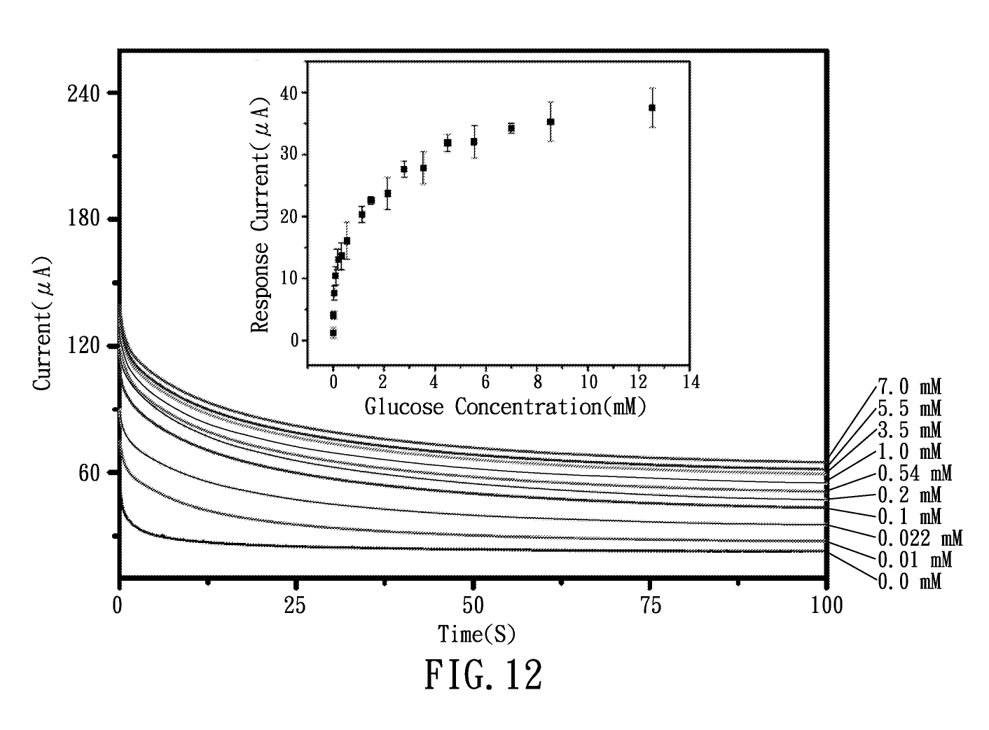

Various concentrations of glucose solution ranging from 1 mM to 5 M were prepared. The glucose solutions were added to the electrochemical device that was saturated with oxygen, and each addition was allowed to react for 90 seconds. Thereafter, a constant voltage −0.5 V was applied and current was allowed to stabilize for 100 seconds before the recording of the current. FIG. 12 is a current vs. time plot. The curves from top to bottom represent various concentrations of glucose solution, which are 0, 0.01, 0.022, 0.1, 0.2, 0.54, 1, 3.5, 5.5 and 7 mM, respectively.

The inset of FIG. 12 shows a response current vs. glucose concentration plot. As shown in this plot, there are two regions where the response current exhibits a linear dependency upon the glucose concentration, which are 0.01-0.54 mM and 1 to 7 mM. In the range of 1 to 7 mM, the sensitivity is 57.2 μA/mM·cm², and the lowest detection range is 8 μM.

To sum up, the electrode of the present invention which comprises an active layer including a polymer having a reactive functional group of formula (A) or (B) and a carboxylated material can be used to detect H₂O₂ and other analytes at reduction potential (−0.4 V or −0.5 V), and has a shorter response time (1.3 seconds), improved sensitivity (up to 1037.6 μA/mM·cm²), broader detection range (0.0025˜12.5 mM), and a lower detection limit (0.331 mM).

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. An electrode for an electrochemical device, comprising:
a conductor; and
an active layer that is formed on said conductor and that includes a polymer with a functional group represented by the formula (A) or (B) and a carboxylated material containing a carboxylic acid group; 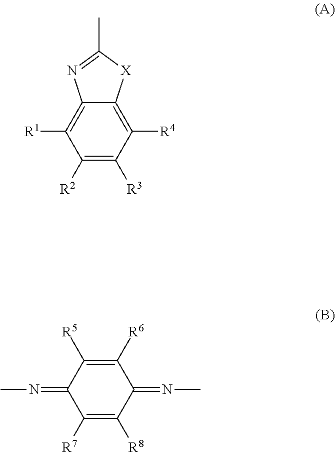
wherein in formula (A), X is O or S; R¹, R², R³ and R⁴ are independently hydrogen, a C₁ to C₁₂ alkyl group, a C₁ to C₁₂ alkoxy group, an ether group, a cycloalkoxy group, a halogen group, a halogenalkyl group, a hydroxyl group, trifluoromethoxy group, a trimethylflouro group, or a phenyl group;
wherein in formula (B), R⁵, R⁶, R⁷ and R⁸ are independently hydrogen, a C₁ to C₁₂ alkyl group, a C₁ to C₁₂ alkoxy group, an ether group, a cycloalkoxy group, a halogen group, a halogenalkyl group, a hydroxyl group, a trifluoromethoxy group, a trimethylflouro group, or a phenyl group; and
wherein the carboxylated material is selected from the group consisting of a carboxylic acid-containing water-soluble polymer, a carboxylated carbon material, and the combination thereof.

2. The electrode according to claim 1, wherein said polymer with said functional group of formula (A) is selected from the group consisting of polyamic acid and polyamide derivatives.

3. The electrode according to claim 2, wherein the polymer has a repeating unit selected from the group consisting of: 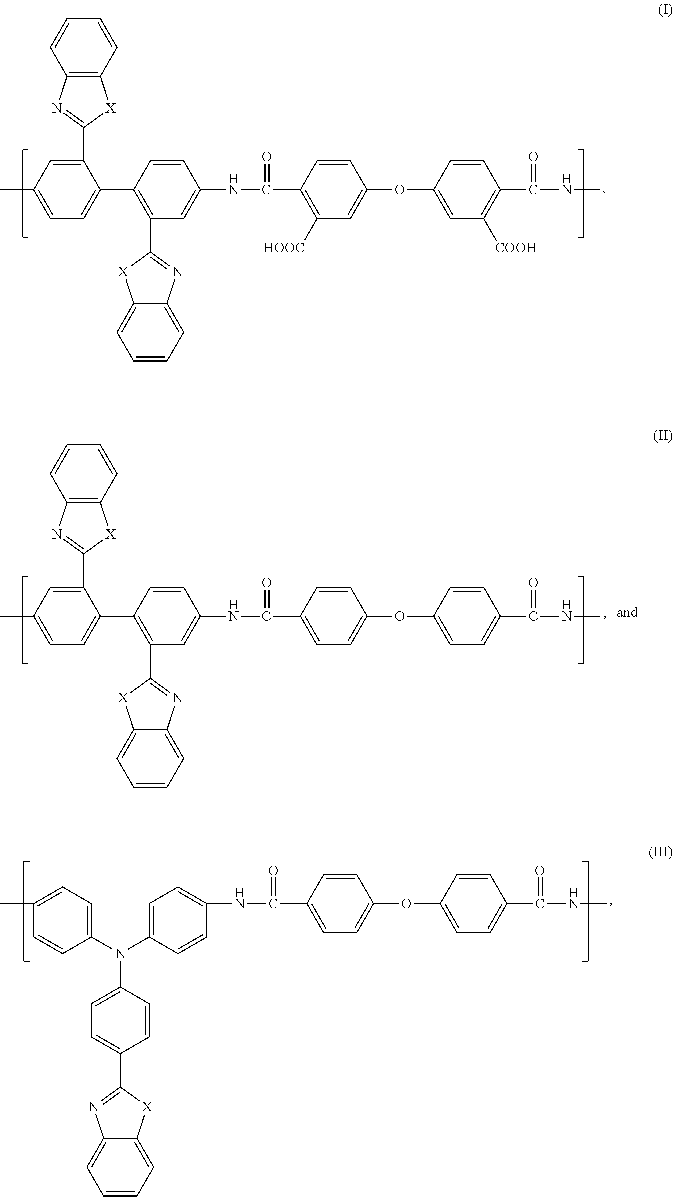
wherein in formula (I), (II) and (III), X is O or S.

4. The electrode according to claim 1, wherein said polymer with said functional group of formula (B) is a polyaniline derivative.

5. The electrode according to claim 4, wherein said polymer with said functional group of formula (B) is a polyaniline having a first repeating unit represented by the following formula (PAn-1) 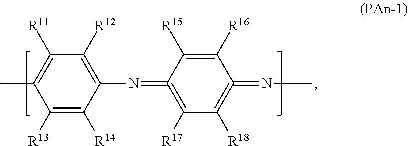
wherein R¹¹, R¹², R¹³, R¹⁴, R¹⁵, R¹⁶, R¹⁷ and R¹⁸ in each occurrence are independently hydrogen, a C₁ to C₁₂ alkyl group, a C₁ to C₁₂ alkoxy group, an oxygen group, a cycloalkoxy group, a halogen group, a halogenalkyl group, a hydroxyl group, a trifluoromethoxy group, a trimethylflouro group, or a phenyl group.

6. The electrode according to claim 5, wherein said polyaniline further includes a second repeating unit represented by the following formula (PAn-2): 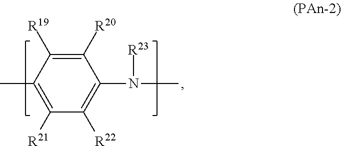
wherein R¹⁹, R²⁰, R²¹, R²² and R²³ in each occurrence are independently hydrogen, a C₁ to C₁₂ alkyl group, a C₁ to C₁₂ alkoxy group, an oxygen group, a cycloalkoxy group, a halogen group, a halogenalkyl group, a hydroxyl group, a trifluoromethoxy group, a trimethylfluoro group, or a phenyl group.

7. The electrode according to claim 1, wherein said carboxylated carbon material is selected from the group consisting of carboxylated carbon tube, carboxylated graphene, carboxylated carbon spheres, and combinations thereof.

8. The electrode according to claim 1, wherein said carboxylic acid-containing water-soluble polymer is selected from the group consisting of polyacrylic acid, poly (2-ethylacrylic acid), poly (2,6-dihydroxymethyl-4-methylphenol-co-4-hydroxy benzoic acid), poly(acrylic acid-co-maleic acid), poly(styrene-co-methacrylic acid), and combinations thereof.

9. The electrode according to claim 1, wherein weight ratio of the polymer to the carboxylated material ranges from 1:0.1 to 1:130.

10. A method for detecting hydrogen peroxide, comprising:
contacting a test sample with an electrode of claim 1 such that nitrogen on the functional group of the polymer of the active layer on the electrode is oxidized;
applying a constant voltage to the electrode to reduce the oxidized nitrogen of the polymer of the active layer such that an electrical current is generated; and
measuring the electrical current.

11. A method for detecting an analyte, comprising:
contacting a test sample with an electrode of claim 1, in the presence of an oxidase, such that nitrogen on the functional group of the polymer of the active layer on the electrode is oxidized;
applying a constant voltage to the electrode to reduce the oxidized nitrogen of the polymer of the active layer such that an electrical current is generated; and
measuring the electrical current.

12. The method according to claim 11, wherein the analyte is selected from the group consisting of glucose, cysteine, hypoxanthine, lactic acid, sterigmatocystin, glutamic acid, choline and cholesterol.
